(19) United States
(12) Patent Application Publication
(10) Pub. No.: US 2005/0275179 A1
(43) Pub. Date: Dec. 15, 2005

(54) Cart with polyurethane hitch and tongue operated parking brake, and with horizontal tilting platform

(76) Inventor: William Darryl Whittington, Birmingham, AL (US)

Correspondence Address: JACOBSON HOLMAN PLLC, 400 SEVENTH STREET N.W., SUITE 600, WASHINGTON, DC, 20004, US

(21) Appl. No.: 11/079,206

(22) Filed: Mar. 15, 2005

Related U.S. Application Data
(60) Provisional application No. 60/552,943, filed on Mar. 15, 2004.
(60) Provisional application No. 60/569,250, filed on May 10, 2004.

(51) Int. Cl. B62B 3/00

(52) U.S. Cl. 280/79.11

(57) ABSTRACT

A cart is provided which may be manually pushed or pulled or towed behind a motorized vehicle. In a first embodiment of the cart, the cart has a three position pulling tongue. In a first position, the pulling tongue locks a rear set of wheels when the tongue is in an uppermost vertical position. When the tongue is lowered to a middle position, the cart can be pushed or pulled by hand. In a lowermost position, extending horizontally, the tongue can be connected to a motorized vehicle, such as a tow motor or tugger, or connected to the rear of another cart for multi-cart transporting. The tongue is made of polyurethane material for light weight and quiet operation. In case of wear, the tongue is easily replaced. In a second embodiment, a platform is raised above a base of the cart. The platform is pivotally mounted on the cart and secured in position by a locking pin. The axis of the tilt mechanism may extend parallel to or perpendicular to a longitudinal axis of the cart.

This application claims priority from and the benefit of U.S. Provisional Application Ser. No. 60/522,943, filed Mar. 15, 2004 and U.S. Provisional Application Ser. No. 60/659,250, filed on May 10, 2004, hereby incorporated in their entirety by reference.

### FIELD OF THE INVENTION

The present invention relates to a pull cart having a three position locking mechanism and a tiltable horizontal platform.

### BACKGROUND OF THE INVENTION

It is oftentimes required to transport goods from one location to another. This movement may be made by a cart pulled by hand or towed by a motor vehicle. Control over the movement of the cart is required to prevent transport of the goods without damage.

It is desirable that the goods be transported to a desired location and that assistance be provided in the unloading of the goods by providing a platform adjustable to the level of the loading dock onto which the goods are transported.

### SUMMARY OF THE INVENTION

By the present invention, a cart is provided which may be manually pushed or pulled or towed behind a motorized vehicle. In a first embodiment of the cart of the present invention, the cart has a three position pulling tongue. In a first position, the pulling tongue locks a rear set of wheels when the tongue is in an uppermost vertical position. When the tongue is lowered to a middle position, the cart can be pushed or pulled by hand. In a lowermost position, extending horizontally, the tongue can be connected to a motorized vehicle, such as a tow motor or tugger, or connected to the rear of another cart for multi-cart transporting.

The tongue is made of polyurethane material for light weight and quiet operation. In case of wear, the tongue is easily replaced.

The bottom of the cart includes two longitudinally extending tubes separated at a distance equal to a separation between the tines of a forklift. A forklift may thereby lift the cart from a front end or a rear end to carry the cart or to stack the cart on shelves.

The two rear wheels of the cart are fixed in position. The two front wheels located adjacent to the tongue are swivel caster wheels to enable turning in any direction.

In the second embodiment of the present invention, a platform is raised above a base of the cart. The platform is pivotally mounted on the cart and secured in position by a locking pin. The axis of the tilt mechanism may extend parallel to or perpendicular to a longitudinal axis of the cart.

By release of the locking pin the platform is allowed to tilt to one side of the cart when the pivot axis is parallel to the longitudinal axis of the cart so as to assist in unloading of transported goods to either side of the cart. In the instance where the pivot axis of the platform extends perpendicular to a longitudinal axis of the cart, the platform will most likely be allowed to pivot towards the rear of the cart to assist in the unloading of goods. It is possible to tilt the platform towards the front of the cart, but with the presence of the tongue at the front of the cart, it may be more difficult to unload goods towards the front of the cart.

The cart bed platform tilts at an angle of approximately 30 degrees to assist in unloading goods from the cart. After the platform is tilted, there is a locking mechanism to maintain the platform locked in the titled position so that the platform may not inadvertently rotate back to the horizontal position or beyond.

Accordingly, it is an object of the present invention to provide a movable cart having fixed rear wheels and rotatable front wheels for use in the transporting of goods.

It is another object of the present invention provide a movable cart having fixed rear wheels and rotatable front wheels for use in the transporting of goods with a movable tongue positioned at the front of the cart for locking the cart or allowing movement of the cart by pulling of the tongue.

It is another object of the present invention provide a movable cart having fixed rear wheels and rotatable front wheels for use in the transporting of goods with a movable tongue positioned at the front of the cart for locking the cart or allowing movement of the cart by pulling of the tongue with the tongue locking the rear wheels of the cart when the tongue is in a vertical orientation.

It is still yet another object of the present invention provide a movable cart having fixed rear wheels and rotatable front wheels for use in the transporting of goods with a movable tongue positioned at the front of the cart for locking the cart or allowing movement of the cart by pulling of the tongue with the tongue locking the rear wheels of the cart when the tongue is in a vertical orientation and with a cart bed platform being tiltably mounted above a base of the cart.

It is still yet another object of the present invention provide a movable cart having fixed rear wheels and rotatable front wheels for use in the transporting of goods with a movable tongue positioned at the front of the cart for locking the cart or allowing movement of the cart by pulling of the tongue with the tongue locking the rear wheels of the cart when the tongue is in a vertical orientation and with a cart bed platform being tiltably mounted above a base of the cart with the cart bed platform being tiltable about an axis extending either perpendicular to or transverse to a longitudinal axis of the cart.

These and other objects of the invention, as well as many of the intended advantages thereof, will become more readily apparent when reference is made to the following description taken in conjunction with the accompanying drawings.

### BRIEF DESCRIPTION OF THE DRAWINGS

FIG. 1 is a plan view of the cart according to the present invention.

FIG. 2 is a side view of the cart shown in FIG. 1, with the tongue shown in three possible positions for locking of the rear wheels of the cart or release of the rear wheels of the cart.

FIG. 3 is a rear view showing a cam assembly as controlled by movement of the tongue to lock and release the rear wheels and tubes for accommodating tines of a forklift.

FIG. 4 is a rear view of a cart having a cart bed platform with a pivot axis extending transverse to a longitudinal axis of the cart.

FIG. 5 is a bottom view of the cart having a transverse pivot axis.

FIG. 6 is a plan view of the transverse pivot axis of the bed platform.

FIG. 7 is a side view illustrating a pivot axis extending parallel to a longitudinal axis of the cart and having a pin lock mechanism for maintaining the horizontal position of the bed platform.

FIG. 8 illustrates a side tipping of the bed platform about a pivot axis extending parallel to a longitudinal axis of the cart.

FIG. 9 illustrates a rearward tipping of the bed platform about a pivot axis extending transverse to a longitudinal axis of the cart.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

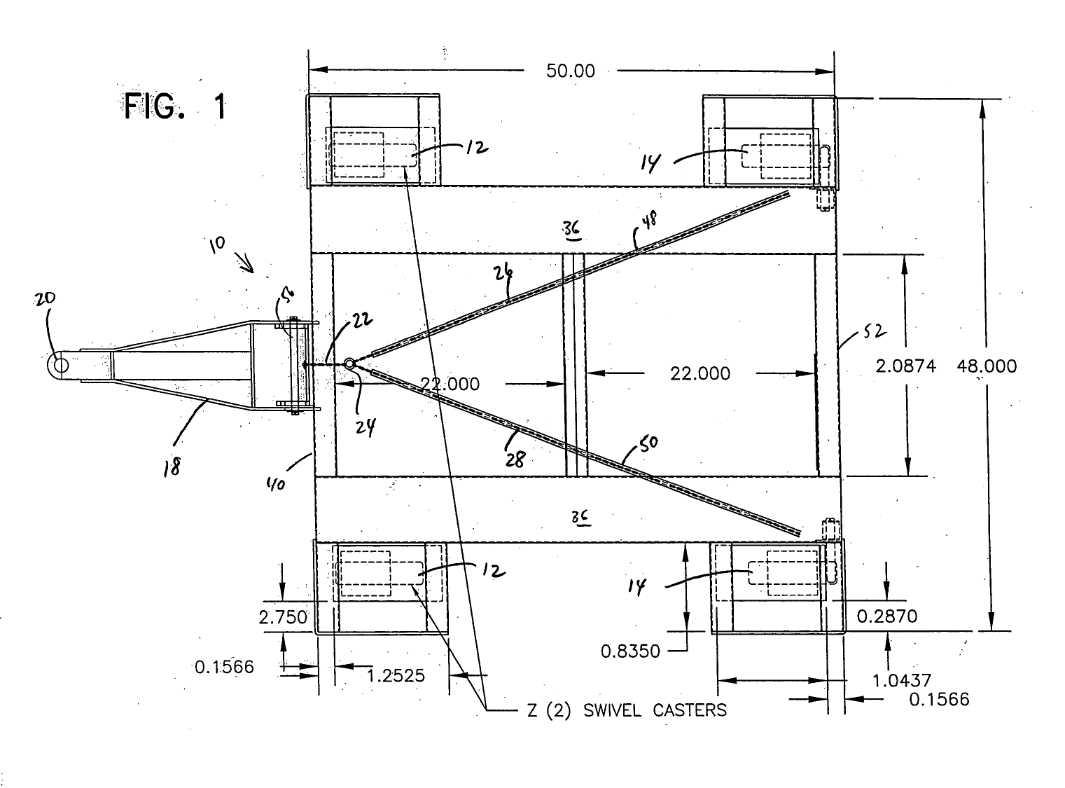

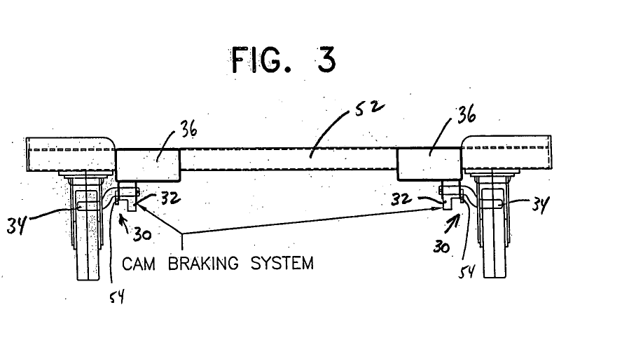

With reference to the drawings, in general, and to FIGS. 1 through 3, in particular, a cart with a polyurethane hitch and tongue operated parking brake embodying the teachings of the subject invention is generally designated as 10. With reference to its orientation in FIG. 1, the cart 10 includes a base frame 16. Secured to the underside of the base frame are two front pivotal caster wheels 12 and two rear fixed direction wheels 14.

Extending from a front end 40 of the frame 16 is a pulling tongue 18. A forward end of the tongue includes a hitch opening 20 for connection to a motorized vehicle. Alternatively, the tongue may be gripped and pulled by the hand of an operator.

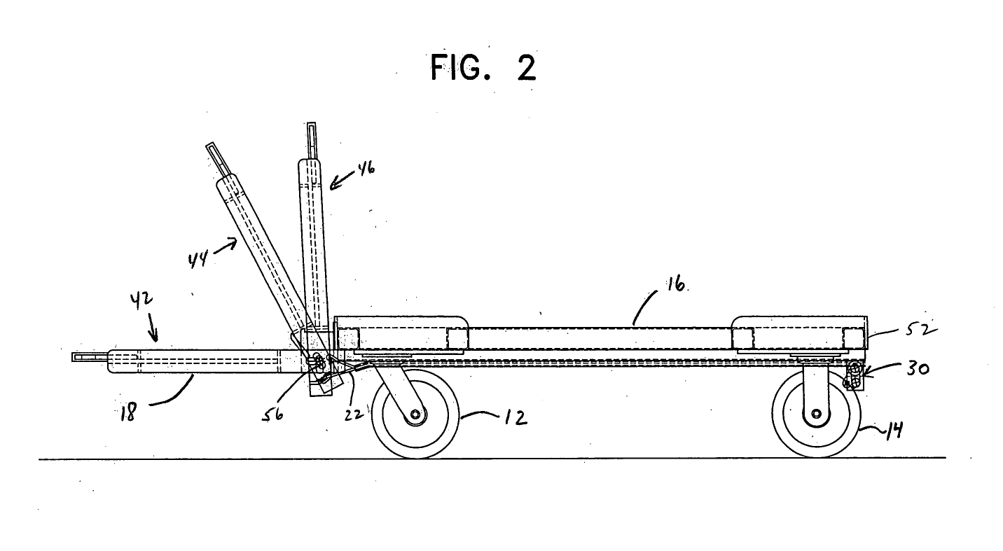

The tongue 18 is pivotable between the three positions shown in FIG. 2 about pivot axis 56. In the horizontal position 42 and in he central, angled position 44, the tongue can be pulled manually or by a vehicle. When the tongue is moved to a vertical position 46, the rear wheels 14 are locked in place against rotation by a cam braking system 30. It is understood that positions 42, 44 and 46 is for a single tongue 18 moved between the three positions.

A cable 22 is connected to the tongue and extends under the frame. The cable is divided at ring 24 into two cable segments 26 and 28 passing through protective tubes 48, 50, respectively. Each cable segment 26, 28 terminates in a cam braking system 30 at each rear wheel.

By lifting of tongue 18 the cable 22 and cable segments 26, 28 are moved forward toward front end 40 to pivot a cam 32 and move a small brake block 34 into engagement with each of the rear wheels 14. The brake block is normally pivoted away from the rear wheels by a bias force of a spring 54 within the cam braking system 30. When the cables 26, 28 are pulled by movement of the tongue 18 to position 46, the bias force is overcome and the brake blocks 34 are moved into engagement with the rear wheels 14.

The rear wheels and thus the cart are locked in position when the tongue is moved to position 46 until the tongue is lowered to position 44 or 42. After towering the tongue 18, the brake blocks are released from engagement with the rear wheels by the bias force and the rear wheels are allowed to rotate.

The rear end 52 of the frame includes two forklift bars 36 for engagement and lifting by a forklift. The bars 36 extend parallel to a longitudinal axis of the cart from the rear end 52 to the front end 40.

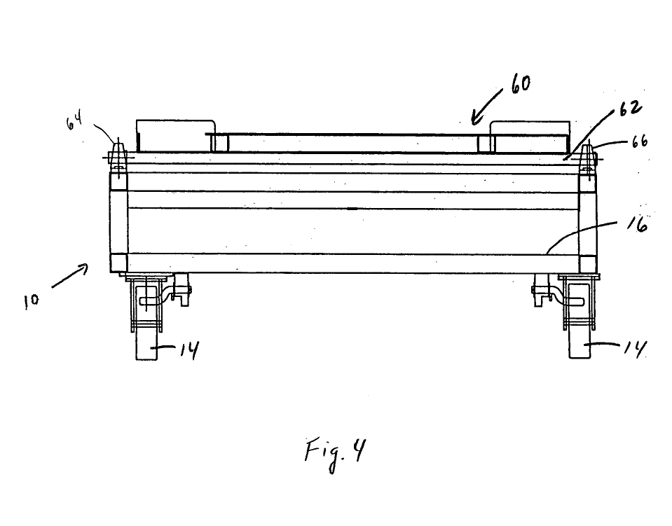

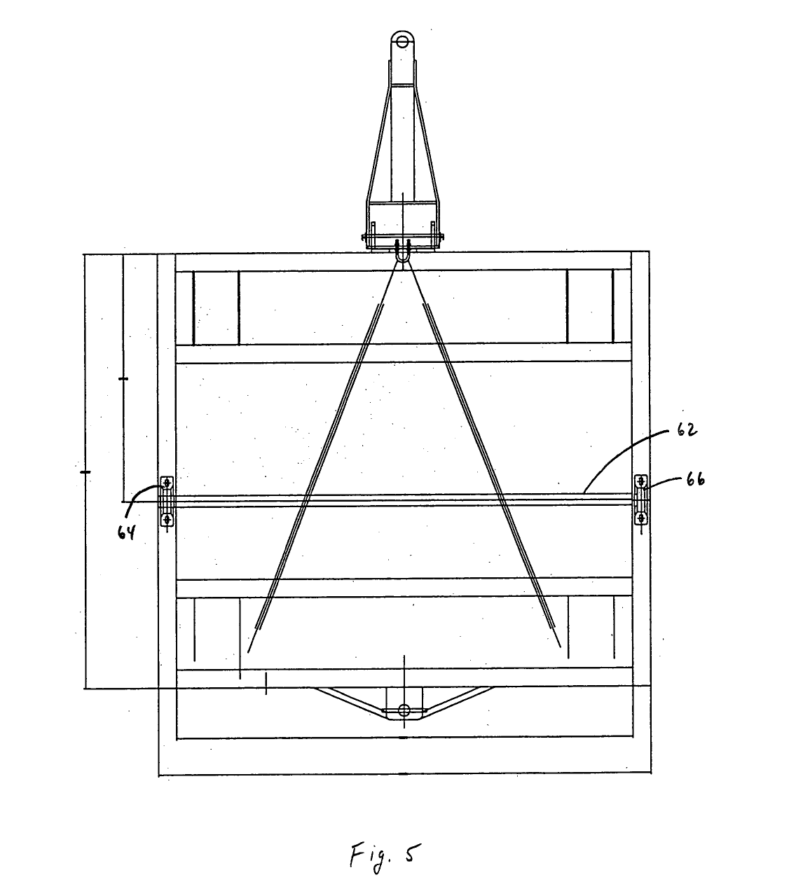

In the embodiment of FIGS. 4 through 9, all of the features of the cart 10, as described and shown with respect to FIGS. 1 through 3, are included. In addition, a cart bed platform 60 is mounted on the cart 10 for a pivotal tilting of the platform 60 to aid in the unloading of cargo, such as assembly or maintenance parts, at a specific location.

The platform 60 in FIGS. 4, 5 and 6, is attached to a pivot bar 62 anchored in pivot brackets 64, 66. The pivot brackets 64, 66 are located on opposite sides of the cart such that the pivot rod 62 extends transversely across the cart, perpendicular to the longitudinal axis of the cart.

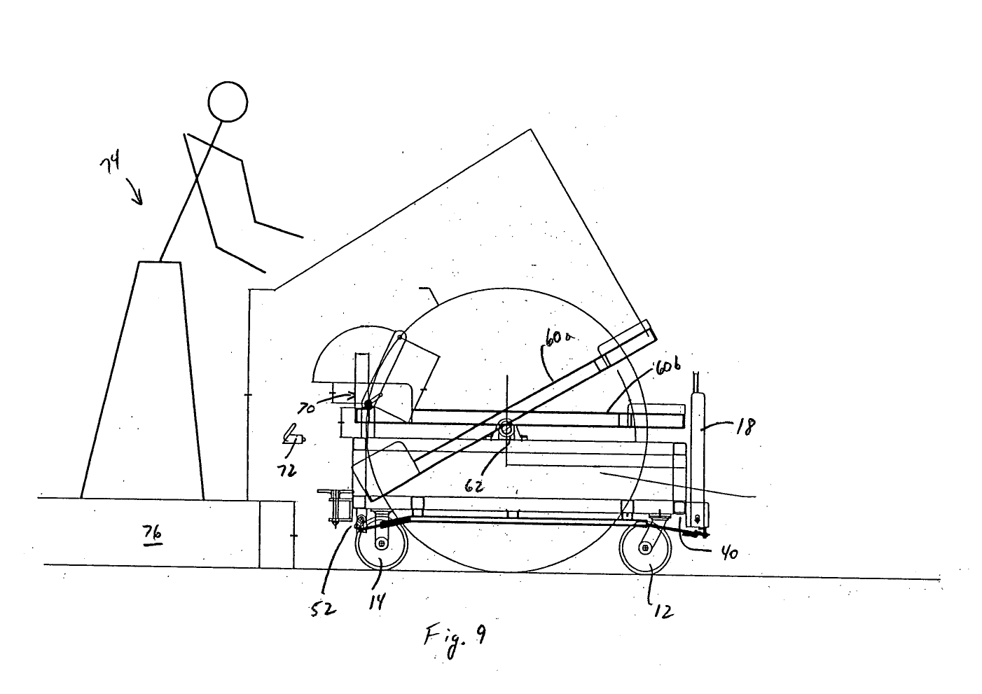

As shown in FIG. 9, the platform 60b, maintained in a horizontal orientation above the cart 10, rests on pivot bar 62 and is locked in a horizontal orientation by a pin locking assembly 70 so as to maintain its horizontal orientation. Upon the release of pin locking mechanism 70 the platform 60a is allowed to tilt 30 degrees towards the rear end 52 of the cart and reengaged in the tilted position by a removable locking pin assembly 72. This maintains the titled position of the platform 60a.

In this position, a worker 74 standing on a elevated loading dock 76 can reach the tilted platform 60a which is elevated by the overall height of the cart 10 to a height proximate to that of the height of the loading dock 76. This facilitates removal of the cargo from the tilted platform 60a.

In the locked position shown by platform 60b, a pin interengages with the platform and a side rail of the cart. Similarly, a pin engages the tilted platform 60a and a side rail of the cart to maintain the tilted position.

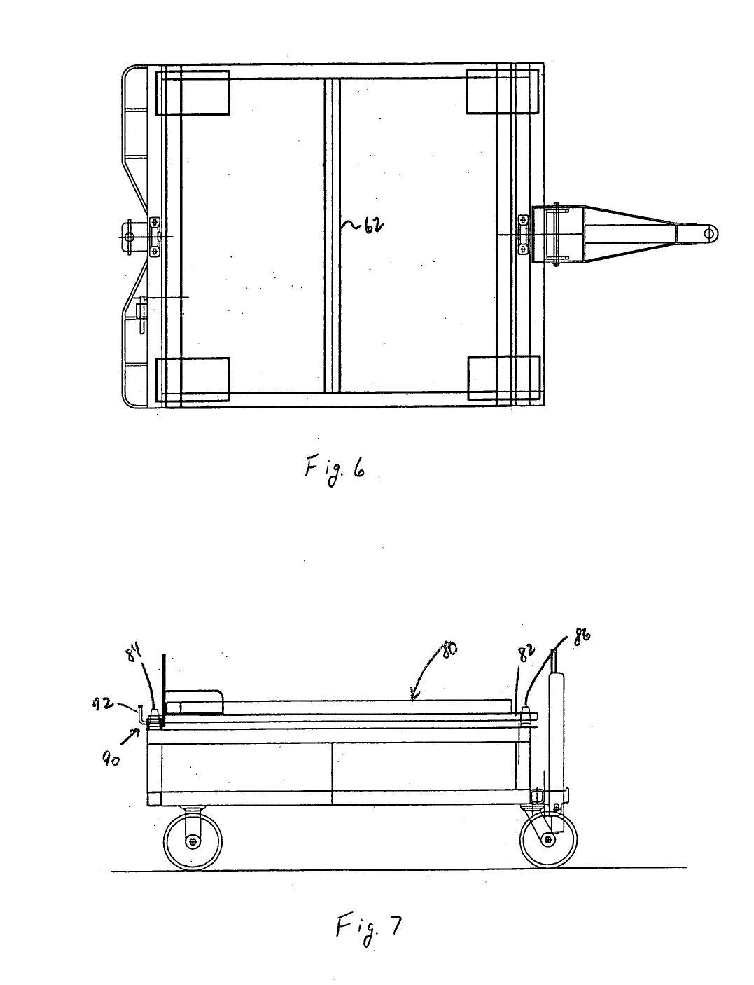

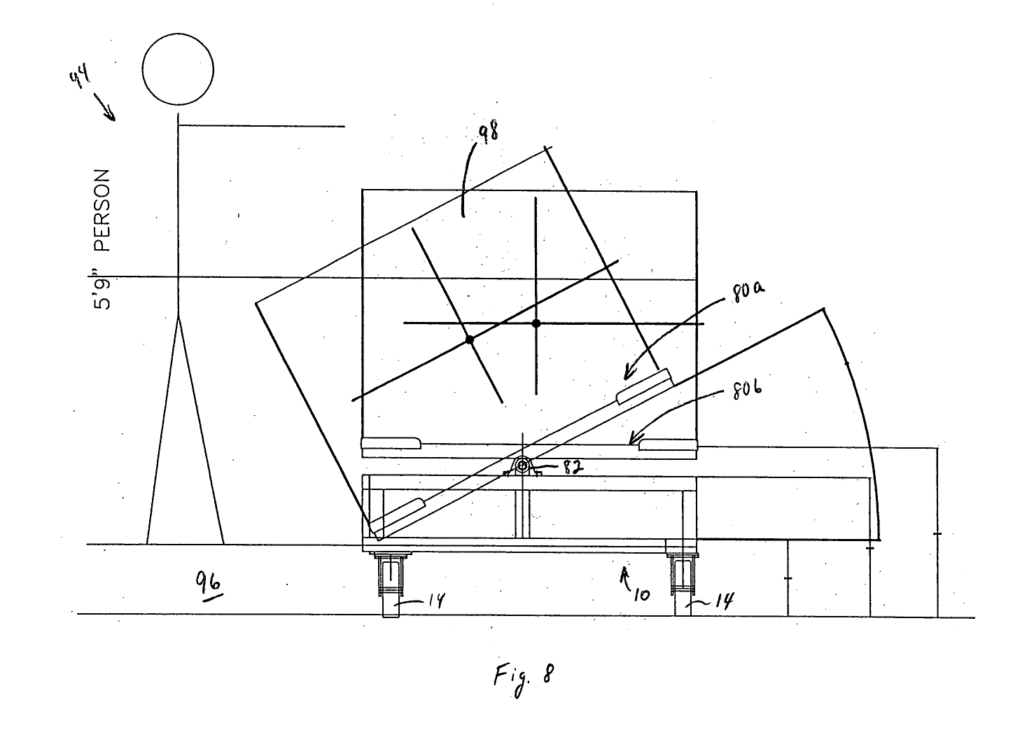

As shown in FIGS. 7 an 8, a platform 80 is mounted on a pivot bar 82 held by pivot bar brackets 84 and 86 with the pivot bar 82 extending parallel to a longitudinal axis of the cart. A locking pin assembly 90 having L-shaped pin 92 extends through the platform and into a side rail of the cart so as to maintain the platform 80 in a horizontal orientation.

Upon removal of the pin 92 as shown in FIG. 8, the platform 80a is shown tilted at a 30 degree angle toward one side of the cart. A locking pin locks the tilted platform 80a in a 30 degree angle with respect to the previously positioned horizontally extending platform 80b so as to maintain the position of the platform 80a.

A worker 94 standing on a loading dock 96 can remove cargo 98 from the tilted platform 80a, at the height of the platform 96. After the cargo is removed, the tilted platform 80a can be moved to a horizontal oriented platform 80b and re-locked in position for subsequent reloading of the cart 10.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

1. A cart for transporting goods, said cart comprising:
a base,
a pair of front wheels rotatably mounted on the base,
a pair of rear wheels rotatably mounted on the base, and
a tongue pivotably mounted on the base, said tongue being movable between a first position and a second position,
said tongue, when in said first position, locks said rear wheels so as to prevent movement of the base.

2. The cart for transporting goods as claimed in claim 1, wherein the front wheels are pivotally mounted on the base.

3. The cart for transporting goods as claimed in claim 1, wherein said tongue extends vertically when said tongue is in said first position.

4. The cart for transporting goods as claimed in claim 3, wherein a cable extends between said tongue and a locking mechanism located at said rear wheels, and said rear wheels are engaged by said locking mechanism when said tongue is in said first position.

5. The cart for transporting goods as claimed in claim 1, further comprising a tiltable platform mounted on said base.

6. The cart for transporting goods as claimed in claim 5, wherein said tiltable platform is mounted on a pivot rod extending transverse to a longitudinal axis of said base.

7. The cart for transporting goods as claimed in claim 5, wherein said tiltable platform is mounted on a pivot rod extending perpendicular to a longitudinal axis of said base.

8. The cart for transporting goods as claimed in claim 1, wherein said tongue, when in said second position, extends from a front end of the base at an acute angle.

9. The cart for transporting goods as claimed in claim 6, wherein said platform tilts towards a rear end of the base.

10. The cart for transporting goods as claimed in claim 7, wherein said platform tilts to one side of the base.

11. A cart for transporting goods, said cart comprising:
a base,
a pair of front wheels rotatably mounted on the base,
a pair of rear wheels rotatably mounted on the base,
a tongue pivotably mounted on the base, said tongue being movable between a first position and a second position,
said tongue, when in said first position locks said rear wheels so as to prevent movement of the base, and
a platform pivotally mounted on a pivot bar extending across the base, said platform being locked in one of a tilted position and a horizontal position.

12. The cart for transporting goods as claimed in claim 11, wherein said tiltable platform is mounted on a pivot rod extending transverse to a longitudinal axis of said base.

13. The cart for transporting goods as claimed in claim 11, wherein said tiltable platform is mounted on a pivot rod extending perpendicular to a longitudinal axis of said base.

14. The cart for transporting goods as claimed in claim 12, wherein said platform tilts towards a rear end of the base.

15. The cart for transporting goods as claimed in claim 13, wherein said platform tilts to one side of the base.
